(19) United States
(12) Patent Application Publication
(10) Pub. No.: US 2007/0140672 A1
(43) Pub. Date: Jun. 21, 2007

(54) Portable cart for heating a liquid, maintaining the liquid in a heated state and dispensing the heated liquid

(76) Inventor: Thomas J. Fellinger, Littleton, CO (US)

Correspondence Address: JOHNS MANVILLE, 10100 WEST UTE AVENUE, LITTLETON, CO, 80127, US

(21) Appl. No.: 11/314,435

(22) Filed: Dec. 21, 2005

(51) Int. Cl. H05B 3/78

(52) U.S. Cl. 392/447

(57) ABSTRACT

This invention relates generally to liquids used in the application of sprayed insulation, and more particularly to a cart for heating such a liquid, maintaining the liquid at desired working, storage or elevated temperatures in various environments of lower temperature and dispensing the heated liquid. A portable cart for heating a liquid, maintaining the liquid in a heated state and dispensing the heated liquid comprises a frame and an insulated housing carried by the frame that defines an interior space. A reservoir and a dispensing system are located within the interior space of the housing. The reservoir contains the liquid while the dispensing system, in fluid communication with the reservoir, dispenses the liquid. To maintain the liquid at the desired working, storage or elevated temperatures, a heat source is also located within the interior space of the housing and is operably associated with the reservoir. A control is operably associated with the heat source and dispensing system for respectively controlling the temperature of the liquid in the reservoir and the flow of the liquid through the dispensing system. An electrical generator is also preferably located on the cart and operably associated with the control for selectively providing electrical energy to at least the heat source and optionally the pump of the dispensing system.

### TECHNICAL FIELD OF THE INVENTION

This invention relates generally to liquids used in the application of sprayed insulation, and more particularly to a cart for heating such a liquid, maintaining the liquid at desired working, storage or elevated temperatures in various environments of lower temperature and dispensing the heated liquid.

### BACKGROUND OF THE INVENTION

Sprayed insulation is commonly used in the construction industry for insulating the open cavities of building walls, floors, ceilings, attics and other areas. Insulating materials, such as loose fiberglass, rock wool, mineral wool, fibrous plastic, cellulose, ceramic fiber, etc. that is combined with an adhesive or water, are sprayed into such open cavities to reduce the rate of heat loss or gain there-though. The adhesive properties of the insulation mixture, comprising insulation combined with the adhesive or water, allow it to adhere to vertical or overhanging surfaces, thus allowing for an application of insulation prior to the installation of wallboard and similar cavity enclosing materials.

Various systems have been devised for the application of spayed insulation mixtures into open cavities. Such systems typically utilize a loose insulation blower that draws loose insulation out of a hopper and pneumatically conveys it through a hose and out of the end of an applicator nozzle. The adhesive that is mixed with the insulation is preferably a liquid adhesive that is sprayed as a mist onto the airborne insulation as it leaves the outlet end of the applicator nozzle. The water may also be sprayed onto the airborne insulation when the insulation includes a dry adhesive material, with the water thereafter activating the adhesive properties of the material. The liquid adhesive or water is typically pumped from a reservoir, through a hose, and out through one or more spray tips located proximal to the end of the applicator nozzle.

The preferred liquid adhesive combined with the airborne insulation preferably comprises a fast drying adhesive having high-tack qualities and belonging to the aqueous polyester oligomer group. This adhesive typically has a preferred working or application temperature range of from about 50 deg. F. to about 70 deg. F. and a preferred storage temperature range of from about 40 deg. F. to about 100 deg. F. In addition to having preferred application and storage temperature ranges, the liquid adhesive or water also has a preferred elevated application temperature of about 150 deg. F., which is optionally utilized to increase the drying rate of the sprayed insulation. Because the adhesive is water based, it is affected by cold temperatures, thus having a freezing point of about 25 deg. F. Water, if used, of course has a freezing point of about 32 deg. F.

However, it may nonetheless be desirable to utilize the liquid adhesive or water to apply sprayed insulation in climates having temperatures that fall below the optimal working and storage temperature ranges and possibly their respective freezing points. For example, in Canada or northern regions of the United States, it may be desirable to apply sprayed insulation during the winter months where outside temperatures can fall to below 0 deg. F. Because the optimal working and storage temperature ranges for the liquid adhesive and water is well above such winter temperatures, the liquid adhesive or water must be prevented from freezing and thus must be maintained within its working or storage temperature ranges. Similarly, when utilizing the liquid adhesive or water at an elevated temperature to increase the drying rate of the insulation mixture, the elevated temperature must be maintained within various environments (i.e. cold, moderate or warm) because such environments typically have a temperature lower than that of the elevated liquid temperature (i.e. lower than about 150 deg. F.).

To prevent the liquid adhesive or water from freezing, an aqueous antifreeze additive such as propylene glycol may be added to adjust their respective freezing points. For example, the addition of antifreeze additives to the liquid adhesive or water allows a freezing point as low as 0 deg. F. However, the addition of such antifreeze additives to the liquid adhesive or water is undesirable because it reduces the initial tack strength of the adhesive during installation of the insulation, possibly resulting in a fall-out of insulation from the cavity where it is applied. An alternative to adding antifreeze to the liquid adhesive or water includes heating the respective liquids via the present methods used to heat and maintain the liquids within their working and storage temperature ranges, as described below. However, as will be readily apparent, various disadvantages are associated with these present methods.

To maintain the liquid adhesive or water within their working or storage temperature ranges within cold environments or at an elevated temperature within any environment of lower temperature, it may be necessary to heat the respective liquids. This is especially true when the liquids are transported to and from a given job site and/or stored or used at the job site. In transporting the liquid adhesive or water to and from a given job site, the liquids are typically stored in a day-tank located on a cart, with the cart typically loaded into the back of a truck or trailer for transportation to and from the job site. Within cold environments, the back of the truck or trailer that holds the cart is often heated via the truck itself or via added, portable heaters placed into the truck or trailer. Such measures, however, are undesirable because a truck having heated storage areas is costly, as is the purchase of added, portable heaters used in lieu of the heated truck.

As an alternative to heating the truck, heating elements and a protective jacketing have been added to the day-tank of the cart. However, because the protective jacketing of the day-tank is directly exposed to lower outside temperatures, the heat generated by the heating elements is generally lost through the jacketing to the lower outside temperature instead of being transferred to the liquid within the tank. Furthermore, the heating elements on the tank are ineffective in maintaining enough heat in the system to maintain a desired temperature for the liquid pump and hose reel assembly located on the cart with the day-tank. Thus, in cold environments, the liquid adhesive or water in the hose and pump are prone to dropping to a temperature below that of their desired working and storage temperature ranges. Similarly, in any environment of lower temperature, these liquids in the hose and pump are also prone to dropping to a temperature below a desired elevated temperature (i.e. below about 150 deg. F.).

In storing and using the liquid adhesive or water at a given job site within cold environments, it is desirable that the job site be heated, thus allowing the respective liquids to remain within their preferred working and storage temperature ranges. However, because many job sites are not heated, the insulation installer must often rely on the inadequate measures described above to maintain the respective liquids within their preferred temperature ranges. Of course, when maintaining the liquid adhesive or water at an elevated application temperature of about 150 deg. F. to optionally increase the drying rate of the insulation mixture, the foregoing measures also prove to be inadequate or impractical.

Thus, what is needed is a portable, heated liquid storage and conveying cart capable of heating and maintaining the liquid adhesive or water located in the tank within their desired working and storage temperature ranges within cold environments. The cart should be capable of also maintaining the liquids at an elevated temperature within various environments of lower temperature as well. The cart should have the tank located within an insulated interior space to minimize the rate of heat loss through the tank itself. The insulated interior space of the cart should also maintain the liquid adhesive or water located within the pump and hose reel assembly within their desired temperatures. The present invention thus fulfills these foregoing needs.

### SUMMARY OF THE INVENTION

This invention relates generally to liquids used in the application of sprayed insulation, and more particularly to a cart for heating such a liquid, maintaining the liquid at desired working, storage or elevated temperatures in various environments of lower temperature and dispensing the heated liquid. For ease of description, the example of liquid adhesive or water will be used in describing the cart, but it is understood that any possible liquid can be heated and maintained at a desired temperature by the cart as well. A portable cart for heating a liquid, maintaining the liquid in a heated state and dispensing the heated liquid comprises a frame and an insulated housing carried by the frame that defines an interior space. A reservoir and a dispensing system are located within the interior space of the housing. The reservoir contains the liquid while the dispensing system in fluid communication with the reservoir dispenses the liquid.

To heat and maintain the liquid adhesive or water at the desired working, storage or elevated temperatures, a heat source is also located within the interior space of the housing and is operably associated with the reservoir. A control is operably associated with at least the heat source and the dispensing system for respectively controlling the temperature of the liquid in the reservoir and the flow of the liquid through the dispensing system. An electrical generator is operably associated with the control for selectively providing electrical energy to at least the heat source. While generator preferably provides 120 Volts (peak to peak) of power, the generator may provide 220 Volts of power as well. Although the generator is preferably located on the cart, it may be located remotely of the cart as well.

The frame preferably comprises a longitudinal platform defining a support surface for supporting the other components of the cart. The insulated housing supported by the frame is comprised of a plurality of insulated sections that define a lower portion, at least one wall, and an upper portion to define the interior space. Openings are defined in the housing to enable access to at least the dispensing system and reservoir located within the housing's interior space. A removable cover or door is preferably located at each opening to enable the closure of each.

The reservoir for holding the liquid is located on the cart within the interior space defined by the housing. The reservoir has an outer surface that defines a volume of from about 5 gallons to about 330 gallons and is preferably comprised of a non-corrosive and non-reactive material suitable for holding aqueous solutions. An access opening or fill port is defined at an upper end of the reservoir to allow access to the reservoir's interior. The reservoir's contents, such as the liquid adhesive or water, may thus be poured or pumped into the reservoir through the fill port. A vent opening is also preferably defined at the upper end of the reservoir to facilitate proper venting during fluid flow into or out of the reservoir and to prevent a pressurization of the system. A dispensing opening is defined proximal to a lower end of the reservoir and is adapted for fluid communication with the dispensing system while a thermostat or thermocouple port is also defined proximal to the lower end for fluid communication with a thermostat or thermocouple.

The dispensing system, located along with the reservoir within the interior space of the housing, comprises a pump in fluid communication with the reservoir and a dispensing hose in fluid communication with the pump. The pump is driven by either an electric motor that receives electrical energy from either the electrical generator or an electrical outlet, or by a hydraulic motor that receives hydraulic energy from a hydraulic drive. A hose reel assembly is preferably located within the interior space of the housing for storing the dispensing hose.

At least the heat source receives electrical energy from either the generator or the outlet. In one embodiment of the invention, the heat source comprises a plurality of resistive heating elements in contact with an outer surface of the reservoir. Other embodiments of the heat source comprise at least one indirect or direct immersion heater located within the reservoir. Regardless of the type of heat source utilized, both the liquid within the reservoir and the interior space defined by the housing are heated by the heat source and maintained at predetermined temperatures.

To control the temperature of the liquid located inside the reservoir as well as to control the flow of liquid through the dispensing system, a control is operably associated with both the heat source and the dispensing system pump motor. The control, preferably located on a panel outside the housing, preferably comprises at least a temperature control and a liquid control. One embodiment of the temperature control preferably comprises an on/off switch and a pre-set, bi-metal thermostat while an alternate embodiment of the temperature control preferably comprises an on/off switch, a temperature regulator and a thermocouple. The liquid control for embodiments of the system utilizing an electric pump motor preferably comprises an on/off switch and a variable frequency drive, while for embodiments of the invention utilizing a hydraulically driven pump motor, the liquid flow control comprises a hydraulic regulator.

To provide electrical energy to the heat source and to the electric motor, if used to drive the pump of the dispensing system, either an electrical generator or a common electrical outlet may be utilized. Both the electrical generator and the electrical outlet preferably provide 120 Volts (peak to peak) or 220 Volts of power. While electrical generator is preferably located on the cart outside of the housing, it may also be located remotely of the cart as well (i.e. on the truck or elsewhere on the job site). The electrical generator may be driven by a gasoline engine, but is preferably driven by a hydraulic motor that hydraulic energy from the hydraulic drive. The operable association of the generator and electrical outlet with the control preferably comprises a power selection switch, preferably located on the panel outside of the housing, for selecting either the generator or the electrical outlet to power the heat source and electric motor, if used to drive the pump of the dispensing system.

In use in heating a liquid, maintaining the liquid in a heated state with the portable cart and dispensing the heated liquid there-from, the power selection switch of the control is actuated to choose either the electrical generator or an electrical outlet as the cart's power source. After choosing a given power source, the heat source is energized via an operation of the on/off switch of the temperature control to receive electrical energy from the chosen power source. The heat source heats the liquid to the desired working, storage or elevated temperature. The interior space, defined by the housing located on the cart enclosing both the reservoir and the dispensing system in fluid communication therewith, is also heated by the heat source. The heat source, via the thermostat or temperature regulator of the temperature control, thereafter maintains the liquid in the heated state at the desired temperature. Once the liquid is in the heated state at the desired working, storage or elevated temperature, the heated liquid is dispensed from the reservoir with the motor-driven pump of the dispensing system.

### BRIEF DESCRIPTION OF THE DRAWINGS

FIG. 1 is a front elevation view illustrating one embodiment of the cart having the housing illustrated in section;

FIG. 2A is a front perspective view illustrating a preferred embodiment of the reservoir of the cart;

FIG. 2B is a front perspective view illustrating an alternate embodiment of the reservoir of the cart;

FIG. 3 is a front perspective view illustrating the components of the dispensing system of the cart;

FIG. 4A is a front perspective view illustrating the preferred embodiment of the reservoir in phantom and highlighting alternate embodiments of the heat source of the cart;

FIG. 4B is a front perspective view illustrating an alternate embodiment of the reservoir in phantom and highlighting alternate embodiments of the heat source of the cart;

FIG. 5 is a front perspective view illustrating the control for the cart;

FIG. 6A is a schematic electrical diagram illustrating the operation of one embodiment of the temperature control in relation to the operable components of the cart;

FIG. 6B is a schematic electrical diagram illustrating the operation of an alternate embodiment of the temperature control in relation to the operable components of the cart; and

FIG. 7 is a schematic electrical diagram illustrating the operation of an embodiment of the liquid control in relation to the operable components of the cart.

### DESCRIPTION OF THE PREFERRED EMBODIMENTS

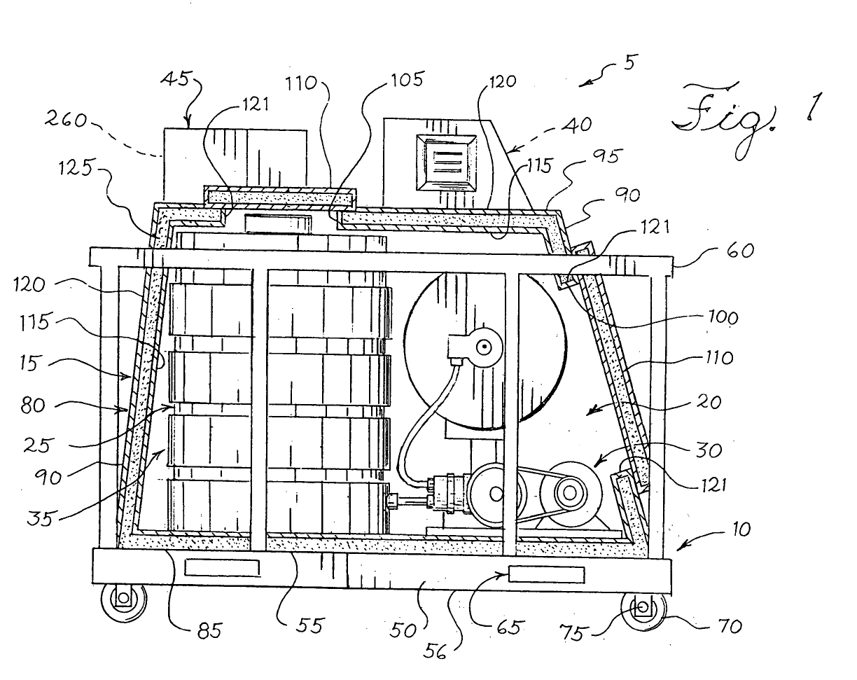

This invention relates generally to liquids used in the application of sprayed insulation, and more particularly to a cart for heating such a liquid, maintaining the liquid at desired working, storage or elevated temperatures in various environments of lower temperature and dispensing the heated liquid. For ease of description, the example of liquid adhesive or water will be used in describing the cart, but it is understood that any possible liquid can be heated and maintained at a desired temperature by the cart as well. FIG. 1 illustrates the basic components of one embodiment of a portable cart 5 for heating a liquid, maintaining the liquid in a heated state and dispensing the heated liquid. As illustrated therein, the cart 5 comprises a frame 10 and an insulated housing 15 (shown in section) carried by the frame that defines an interior space 20.

A reservoir 25 and a dispensing system 30 are located within the interior space 20 of the housing 15. The reservoir 25 contains the liquid, preferably liquid adhesive or water, while the dispensing system 30 in fluid communication with the reservoir dispenses the liquid. To heat and maintain the liquid adhesive or water at the desired working, storage or elevated temperatures, a heat source 35 is also located within the interior space 20 of the housing 15 and is operably associated with the reservoir 25. A control 40 is operably associated with at least the heat source 35 and the dispensing system 30 for respectively controlling the temperature of the liquid in the reservoir and the flow of the liquid through the dispensing system. An electrical generator 45 is operably associated with the control 40 for selectively providing electrical energy to at least the heat source 35. The generator 45 preferably provides 120 Volts (peak to peak) of power. However, the generator 45 may provide 220 Volts of power as well. Although the generator 45 is illustrated in FIG. 1 as preferably located on the cart 5, it may be located remotely of the cart as well (i.e. on the truck or elsewhere on the job site).

The frame 10 preferably comprises a longitudinal platform 50 defining a support surface 55 for supporting the other components of the cart 5. Because the cart 5 will be used in a construction setting and transported to numerous construction job sites, the frame 10 is comprised of a rigid material, such as steel, aluminum, wood, plastic, or some other durable material. The frame 10 may optionally define one or more peripheral rails 60 above the platform 50 that surround and protect the housing 15, as well as the reservoir 25 and dispensing system 30 located therein, from impacts that may occur at the job site or during transportation of the cart 5 to and from the job site.

To facilitate the transportation of the cart 5 to and from various construction job sites, the frame 10 preferably defines a pair of openings 65 in the platform 50 below the support surface 55 adapted for engagement with the forks of a forklift. A plurality of wheels 70 is preferably attached to a lower surface 56 of the platform 50, via rotatable casters 75, to allow the cart 5 to be rolled between locations. The wheels 70 are preferably lockable to enable the cart 5 to be safely secured when in a desired location.

The insulated housing 15 supported by the frame 10 is comprised of a plurality of insulated sections 80 that define a lower portion 85, at least one wall 90, and an upper portion 95 to define the interior space 20. At least one wall opening 100 is defined in the at least one wall 90 to enable access to at least the dispensing system 30 located within the housing's interior space 20. Similarly, at least one upper opening 105 is defined in the upper portion 95 to enable access to at least the reservoir 25 also located within the housing's interior space. A removable cover 110 or door is preferably located at each opening 100 and 105 to enable the closure of each.

The insulated sections 80 and removable covers 110 preferably comprise an inner and outer shell 115 and 120 having a rigid insulation material 125 located there-between. The ends of the sections are capped with ends 121. The rigid insulation material 125 is preferably from about 1 to about 3 inches thick and has an R-value in the range of from R-10 to R-14. In the preferred embodiment, the insulation material 125 is preferably about 2 inches thick and has an R-value of R-12. The inner and outer shells 115 and 120 and ends 121 of the sections 80 are comprised of a durable, waterproof material that resists punctures, abrasions and other such damaging contact expected at a construction job site. In the preferred embodiment, the shells 115 and 120 are comprised of sheet-form stainless steel. However, it is understood that the shells 115 and 120 may also be comprised of sheet-form aluminum, plastic, composite materials, or other durable materials as well.

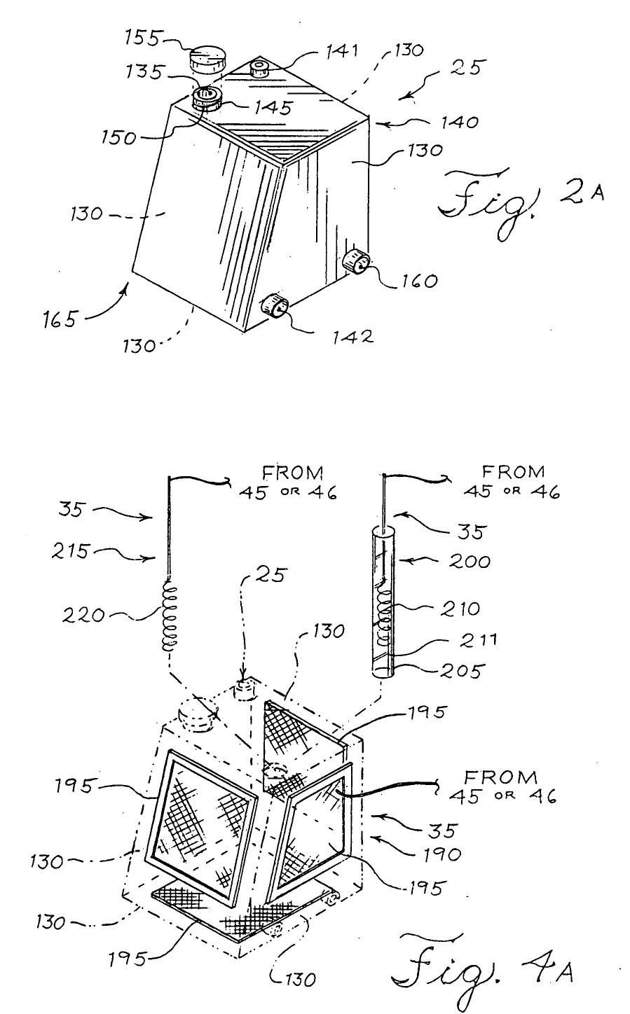

The reservoir 25 for holding the liquid is located on the cart 5 within the interior space 20 defined by the housing 15. FIG. 2A illustrates a preferred embodiment of the reservoir 25 while FIG. 2B illustrates an alternate embodiment. Both embodiments of the reservoir 25 have an outer surface 130 that defines a volume of from about 5 gallons to about 330 gallons. In the preferred embodiment of the invention, each embodiment of the reservoir 25 defines a volume of about 60 gallons. The reservoir 25 is preferably comprised of a non-corrosive and non-reactive material suitable for holding aqueous solutions. Thus, in the preferred embodiment, the reservoir 25 is comprised of stainless steel. However, the reservoir 25 may be comprised of plastic, aluminum, or other similar materials as well.

An access opening or fill port 135 is defined at an upper end 140 of the reservoir 25 to allow access to the reservoir's interior. The reservoir's contents, such as the liquid adhesive or water, may thus be poured or pumped into the reservoir 25 through the fill port 135. The fill port 135 preferably includes a peripheral wall 145 defining a securement means 150 adapted for engagement with a lid 155 sized to cover the opening. The securement means 150 may comprise threads, a peripheral ridge, a resistance fit or other means that are adapted for engagement with like means located on the lid 155. A vent opening 141 is also preferably defined at the upper end 140 of the reservoir 25 to facilitate proper venting during fluid flow into or out of the reservoir and to prevent a pressurization of the system. A dispensing opening 160 is defined proximal to a lower end 165 of the reservoir 25 and is adapted for fluid communication with the dispensing system 30 while a thermostat or thermocouple port 142 is also defined proximal to the lower end for fluid communication with a thermostat or thermocouple, to be discussed further. Although FIG. 2A illustrates a preferred embodiment of the reservoir 25 having an outer surface 130 defining a trapezoidal volume while FIG. 2B illustrates an alternate embodiment of the reservoir having an outer surface that defining a cylindrical volume, it is understood that the outer surface of the reservoir can define a volume having any shape.

The dispensing system 30 is located along with the reservoir 25 within the interior space 20 of the housing 15. As illustrated in FIG. 3, the dispensing system 30 comprises a pump 170 in fluid communication with the reservoir 25 and a dispensing hose 175 in fluid communication with the pump 170. The pump 170 is driven by a motor 180 operably associated with the control 40 to draw the liquid through the dispensing opening 160 of the reservoir 25 and force it through the dispensing hose 175. In one embodiment of the invention, the motor 180 comprises an electric motor 180a that receives electrical energy from either the electrical generator 45 or from a common 120 V (peak to peak) or 220 V electrical outlet 46, each operably associated with the control 40. In another embodiment of the invention, the motor 180 comprises a hydraulic motor 180b that receives hydraulic energy from a hydraulic drive 181. The hydraulic drive 181, comprising any hydraulic pump understood in the art as driving hydraulic motors, is preferably located remotely of the cart. Standard hydraulic hoses and fittings connect the hydraulic drive with the pump's hydraulic motor to enable a fluid communication between the two. With regard to the dispensing system 30 of the cart, a hose reel assembly 185 is preferably located within the interior space 20 of the housing 15 for storing the dispensing hose 175. The reel assembly 185 is thus in fluid communication with and located between the pump 170 and dispensing hose 175.

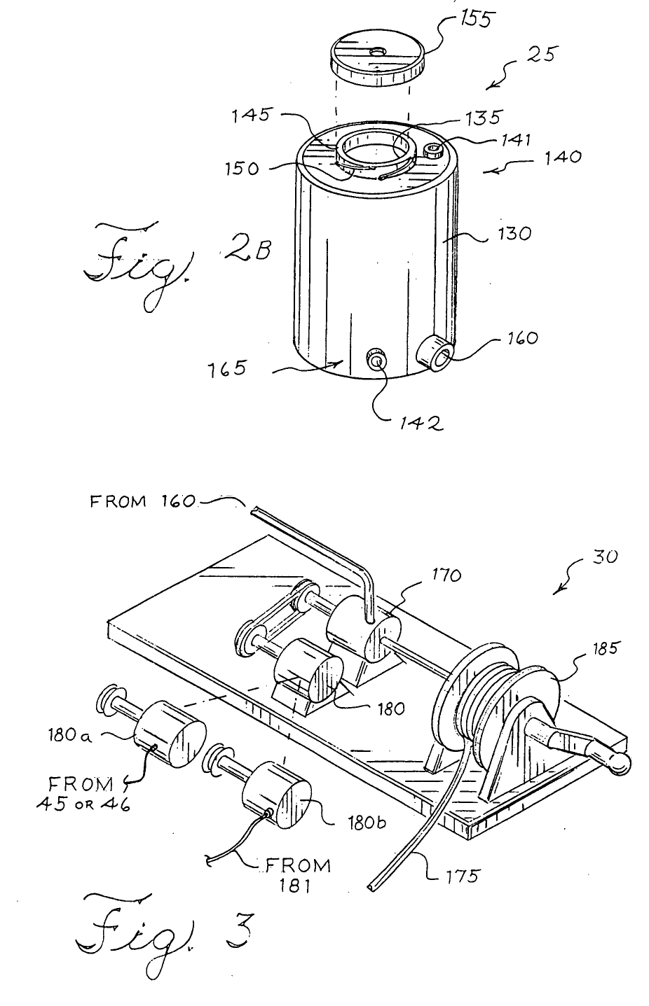

Embodiments of the heat source 35 are illustrated in the alternative in FIGS. 4A and 4B. At least the heat source 35 receives electrical energy from either the generator 45 or the 120 V (peak to peak) or 220 V outlet 46, each operably associated with the control 40. To heat the liquid adhesive or water located within the reservoir 25 and maintain it at the desired working, storage or elevated temperatures, in one embodiment of the invention, the heat source 35 comprises a plurality of resistive heating elements 190 in contact with an outer surface 130 of the reservoir. The heating elements 190 preferably comprise heating pads 195 commonly used in the industry for heating various containers. The heating pads 195 are flexible to allow them to wrap around and/or conform to the outer surface 130 of the reservoir.

In the preferred embodiment illustrated in FIG. 4A, four silicone heating pads 195 are preferably utilized, with each pad preferably having a power rating of about 1 Watt per square inch. Each heating pad 195 preferably has a height of about 20 inches and a width of about 18 inches to define an area of about 360 square inches. However, any heating pad dimension that defines an area of about 360 square inches will suffice. Each heating pad 195 thus preferably has a power output of about 360 Watts to define a total power of about 1440 Watts for the heat source 35. In the alternate embodiment illustrated in FIG. 4B, four silicone heating pads 195 are preferably utilized, again with each pad preferably having a power rating of about 1 Watt per square inch. Each heating pad 195, preferably wrapping around the outer surface 130 of the reservoir 25, preferably has a height of about 4.5 inches and a length of about 78 inches to define an area of about 350 square inches. However, any heating pad dimension that defines an area of about 350 square inches will suffice. Each heating pad 195 thus preferably has a power output of about 350 Watts to define a total power output of about 1400 Watts for the heat source 35.

Additional embodiments of the heat source 35 illustrated in the alternative in FIGS. 4A and 4B comprises at least one indirect immersion heater 200 located within the reservoir 25. The at least one indirect immersion heater 200 comprises a lengthwise cartridge 205 having at least one heating element 210 located therein. The cartridge 205 contacts the liquid located within the reservoir 25 to transfer heat thereto. An air space 211 is preferably located between the at least one heating element 210 and the cartridge 205 to ensure that liquid within the reservoir 25 is indirectly heated. In yet another embodiment illustrated in the alternative in FIGS. 4A and 4B, the heat source 35 comprises at least one direct immersion heater 215 located within the reservoir 25. The at least one direct immersion heater 215 comprises at least one heating element 220 that contacts the liquid located within the reservoir 25 to transfer heat thereto. Each of the at least one heating elements 210 and 220 is preferably about 24 inches long and about ⅝ inches in diameter and has a power output of about 1500 Watts to define a total power output of about 1500 Watts for the heat source 35.

Regardless of the type of heat source 35 utilized, the liquid within the reservoir 25 is heated by the heat source 35 and maintained at predetermined working or storage temperatures in relation to temperatures existing outside of the housing 15. If the outside temperature is greater than about 40 deg. F., the heat source 35 preferably maintains the liquid at a temperature of at least about 50 deg. F. For outside temperatures greater than or equal to about 0 deg. F and less than or equal to about 40 deg. F., the heat source 35 preferably maintains the liquid at a temperature of at least about 70 deg. F. If the outside temperature is less than about 0 deg. F, the heat source 35 preferably maintains the liquid at a temperature of at least about 100 deg. F.

In addition to heating the liquid within the reservoir 25 and maintaining it at a predetermined working or storage temperature, the heat source 35 heats the air within the interior space 20 of the insulated housing 15 and maintains it at predetermined temperatures in relation to the working and storage temperatures of the liquid in the reservoir and the temperatures existing outside of the housing. By heating the air within the interior space 20 and maintaining it at predetermined temperatures, the liquid existing within the pump 181, hose 175 and hose reel assembly 181 is also maintained at predetermined temperatures as well. Thus, if the outside temperature is greater than about 40 deg. F., the heat source 35 preferably maintains the interior space of the housing at a temperature of at least about 45 deg. F. For outside temperatures greater than or equal to about 0 deg. F and less than or equal to about 40 deg. F., the heat source 35 preferably maintains the interior space of the housing at a temperature of at least about 40 deg. F. If the outside temperature is less than about 0 deg. F, the heat source 35 preferably maintains the interior space of the housing at a temperature of at least about 35 deg. F.

With regard to heating the liquid within the reservoir 25 and maintaining it at elevated temperatures to increase the drying rate of the sprayed insulation, the heat source 35 heats the liquid and maintains it at a temperature of at least about 100 deg. F., regardless of the temperature existing outside of the housing 15 of the cart 5. Thus, the liquid is heated and maintained by the heat source 35 at an elevated application temperature of at least about 100 deg. F. regardless of whether the outside temperature is greater than about 40 deg. F., greater than or equal to about 0 deg. F and less than or equal to about 40 deg. F., or less than about 0 deg. F.

In heating the liquid within the reservoir 25 and maintaining it at elevated temperatures, the heat source 35 heats the air within the interior space 20 of the insulated housing 15 and maintains it at predetermined temperatures in relation to the elevated temperatures of the liquid in the reservoir and the temperatures existing outside of the housing. Thus, if the outside temperature is greater than about 40 deg. F., the heat source 35 preferably maintains the interior space of the housing at a temperature of at least about 56 deg. F. For outside temperatures greater than or equal to about 0 deg. F and less than or equal to about 40 deg. F., the heat source 35 preferably maintains the interior space of the housing at a temperature of at least about 45 deg. F. If the outside temperature is less than about 0 deg. F, the heat source 35 preferably maintains the interior space of the housing at a temperature of at least about 35 deg. F.

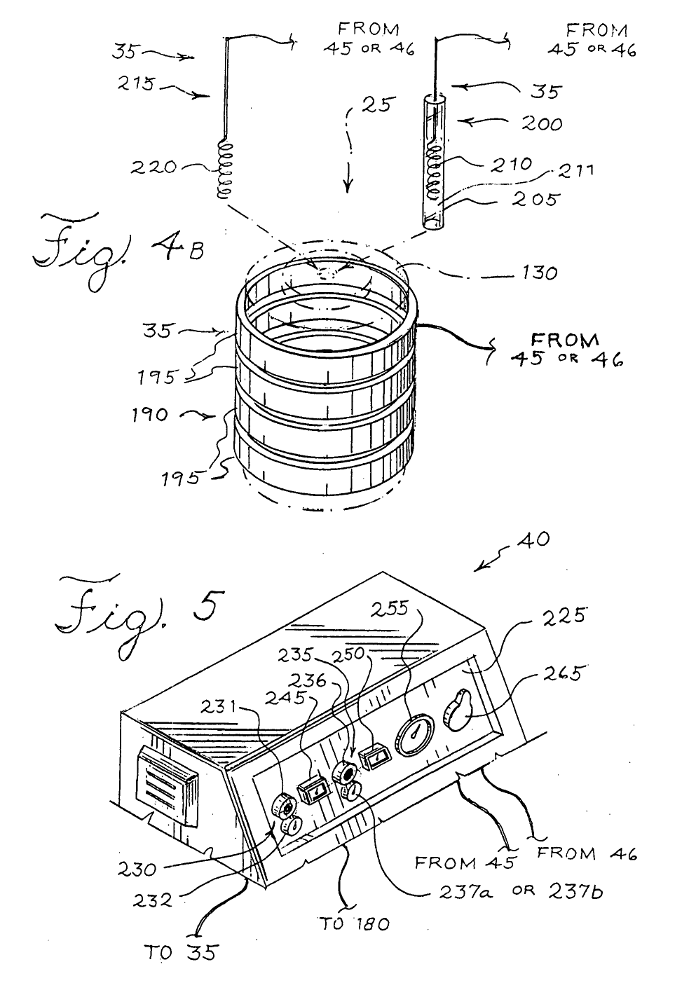

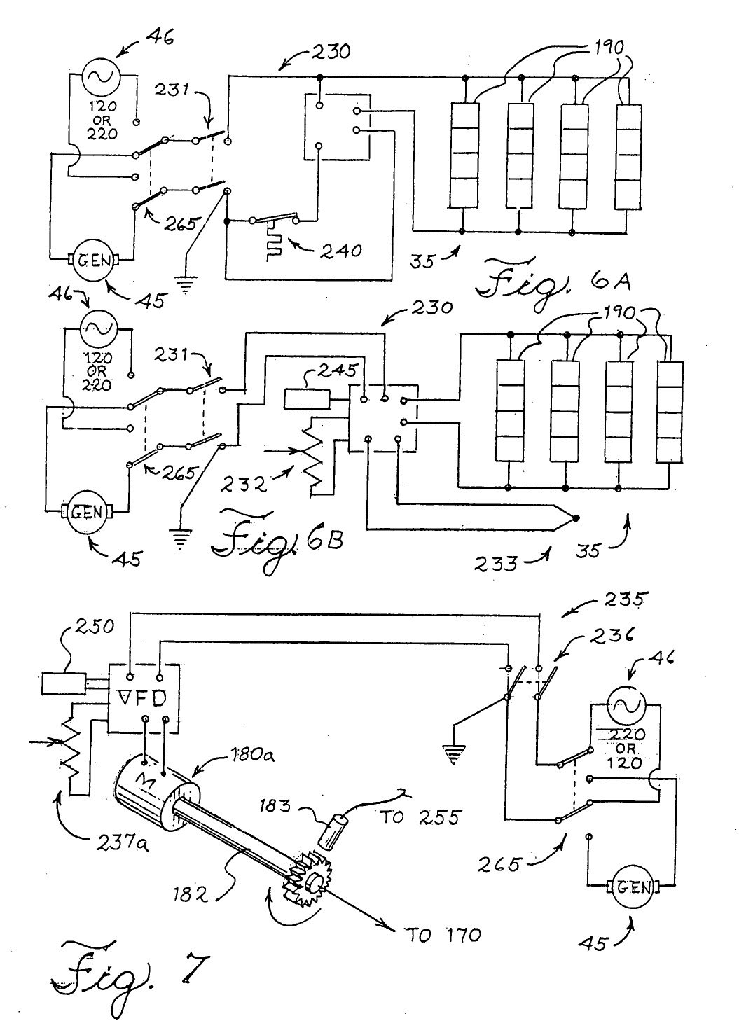

To control the temperature of the liquid located inside the reservoir 25, as well as to control the flow of liquid through the dispensing system 30, a control 40 is operably associated with both the heat source 35 and the dispensing system pump motor 180. The control 40, illustrated in FIG. 5 as preferably located on a panel 225, thus preferably comprises at least a temperature control 230 and a liquid control 235. FIGS. 6A and 6B are schematic circuit diagrams illustrating the operation of alternate embodiments of the temperature control 230 while FIG. 7 is a schematic circuit diagram illustrating the operation of the liquid control 235, both in relation to the operable components of the system.

Referring to FIGS. 5 and 6A, one embodiment of the temperature control 230 preferably comprises an on/off switch 231 and a pre-set, bi-metal thermostat 240. The on/off switch 231 is preferably located on the control panel 225 while the thermostat 24 is preferably located in the port 142 of the reservoir 25 and is in fluid communication with the liquid located therein. The on/off switch 231 energizes and de-energizes the thermostat 240 and heat source 35 while the thermostat 240, once energized via the on/off switch, energizes and de-energizes the heat source in accordance with both the liquid's temperature and the setting of the thermostat itself. Thus, for example, if the thermostat 240 is set for 100 deg. F., it will energize the heat source 35 whenever the temperature of the liquid within the reservoir falls below 100 deg. F. and de-energize the heat source when the liquid's temperature reaches 100 deg. F. Of course, various temperature settings are possible for the thermostat 240 to maintain the liquid at a variety of temperatures. Although not illustrated in FIG. 6, it is understood that either of the immersion heaters 200 or 215 disclosed herein can be utilized in place of the heating elements 190 as well.

As illustrated in FIGS. 5 and 6B, another embodiment of the temperature control 230 preferably comprises an on/off switch 231, a temperature regulator 232 and a thermocouple 233.

The on/off switch 231 is again preferably located on the control panel 225 along with the temperature regulator 232. The thermocouple 233, preferably located in the port 142 of the reservoir 25 and in fluid communication with the liquid located therein, provides the liquid's temperature to a temperature indicator 245 preferably located on the panel 225. The on/off switch energizes and de-energizes the temperature regulator 232 and heat source 35 while the temperature regulator, once energized via the on/off switch, controls the wattage of the heat source. Thus, for example, an adjustment of the temperature regulator 232 will raise or lower the wattage of the heat source 35 to raise or lower the temperature of the liquid, with the liquid's temperature displayed on the indicator 245 to aid in making such adjustments. Although embodiments for controlling the temperature discussed herein respectively include a thermostat and a temperature regulator, it is understood that various other systems and components may be utilized to control the liquid's temperature as well.

Referring now to FIGS. 5 and 7, the liquid control 235 for embodiments of the system utilizing an electric pump motor 180a preferably comprises an on/off switch 236 and a variable frequency drive 237a is illustrated. The on/off switch 236, preferably located on the control panel 255, energizes and de-energizes the variable frequency drive 237a and the electric motor 180a, if used to drive the pump 170 of the dispensing system 30, while the variable frequency drive varies the rotational rate of the motor. The variable frequency drive 237a, as understood in the art, comprises a common adjustable potentiometer that controls the electrical frequency of the voltage supplied to the electric motor 180a of the pump 170. An adjustment of the potentiometer to increase or decrease the electrical frequency of the voltage supplied to the electric motor 180a will increase or decrease the rate of motor's rotational rate, thus increasing or decreasing the flow rate of the pump 170. A frequency indicator 250 is preferably utilized on the panel 225 to indicate the frequency of the voltage supplied to the motor. In the preferred embodiment of the invention, a frequency of from about 15 Hertz to about 20 Hertz is supplied to electric motor 180a of the pump 170. An RPM indicator or tachometer 255, which obtains rotational rate information from the output shaft 182 of the motor via sensor 183, is also preferably utilized on the panel 225 to indicate the motor's rate of rotation. Although a variable frequency drive is preferably utilized to vary the motor's rate of rotation, other mechanisms known in the art, such as rheostats, etc., may be utilized to vary the rotational rate of the motor as well. Furthermore, it is understood that a motor 180a having a fixed rotational rate may be utilized as well, thus altogether eliminating the variable frequency drive.

In embodiments of the invention utilizing a hydraulically driven pump motor 180b, the liquid flow control comprises a hydraulic regulator 237b (not shown in FIG. 7). The hydraulic regulator 237b energizes and de-energizes the hydraulic motor 180b, if used in lieu of the electric motor to drive the pump, and controls the motor's rate of rotation. The hydraulic regulator 237b thus preferably comprises a common valve, such as a gate or globe valve, for energizing and de-energizing the hydraulic motor and regulating the rate of flow of hydraulic fluid from the hydraulic drive to the hydraulic motor 180b of the dispensing system 30. Opening the valve will energize the hydraulic motor while closing the valve will de-energize the motor. An adjustment of the open valve to increase or decrease the flow rate of the fluid supplied to the hydraulic motor 180b will thus increase or decrease the rate of rotation of the motor to thus increase or decrease the flow rate of the pump 170. Again, an RPM indicator 255 or tachometer is preferably utilized on the panel 225 to indicate the motor's rate of rotation.

To provide electrical energy to the heat source 35 and to the electric motor 180a, if used to drive the pump 170 of the dispensing system 30, either an electrical generator 45 or a common electrical outlet 46 may be utilized. Both the electrical generator 45 and the electrical outlet 46 preferably provide 120 Volts (peak to peak) or 220 Volts of power. The electrical generator 45 is preferably located on the cart 5 outside of the housing 15, with the generator operably associated with the control 40. While FIG. 1 illustrates the generator 45 as located on the housing 15 of the cart 5, it is understood that the generator may be located anywhere on the frame 10 as well, to include either the rails 60 of the platform 50. Also, although the generator 45 is preferably located on the cart 5, it may also be located remotely of the cart as well (i.e. on the truck or elsewhere on the job site). The electrical generator may be driven by a gasoline engine, but is preferably driven by a hydraulic motor 260. Similar to the hydraulic motor 180b of the pump 170, the hydraulic motor 260 of the electrical generator receives hydraulic energy from the hydraulic drive 181. Again, standard hydraulic hoses and fittings connect the hydraulic drive with the generator's hydraulic motor to enable a fluid communication between the two.

Referring again to FIGS. 5, 6A, 6B and 7, the operable association of the generator 45 and electrical outlet 46 with the control 40 preferably comprises a power selection switch 265, preferably located on the panel 225, for selecting either the generator 45 or the electrical outlet 46 to power the heat source 35 and electric motor 180a, if used to drive the pump 170 of the dispensing system 30. Thus, if the cart 5 is located at a job-site where an electrical outlet is available, the power selection switch 265 of the control 40 is switched to direct electrical energy from the outlet to the heat source 35 and to the electric pump motor 180a of the dispensing system 30, if used in lieu of the hydraulic motor 180b. However, if the cart 5 cart is located at a job site where an electrical outlet 46 is unavailable, the power selection switch 265 of the control 40 is switched to direct electrical energy from the electrical generator 45 to the heat source 35 and electric pump motor 180a.

In use in heating a liquid (i.e. liquid adhesive or water), maintaining the liquid in a heated state with the portable cart and dispensing the heated liquid there-from, the power selection switch of the control is actuated to choose either the electrical generator or an electrical outlet as the cart's power source. Although the generator is preferably located on the cart, it may be located remotely of the cart as well. Also, although the generator may be driven by a gasoline engine, it is preferably driven by a hydraulic motor receiving hydraulic energy from a hydraulic drive. After choosing a given power source, i.e., the electrical generator or the electrical outlet, the heat source is energized via an operation of the on/off switch of the temperature control to receive electrical energy from the chosen power source. Because the heat source is operably associated with the reservoir located on the cart holding the liquid, preferably liquid adhesive or water, the liquid is thus heated to the desired working, storage or elevated temperatures recited herein.

In one embodiment, the heat source heats the liquid to the desired working, storage or elevated temperature via an operation of the bi-metal thermostat of the control while in an other embodiment, the heat source heats the liquid to the desired temperature via an operation of the temperature regulator of the temperature control. The interior space, defined by the housing located on the cart enclosing both the reservoir and the dispensing system in fluid communication therewith, is also heated by the heat source. The heat source, via the thermostat or temperature regulator of the temperature control, thereafter maintains the liquid in the heated state at the desired temperature.

Once the liquid is in the heated state at the desired working, storage or elevated temperature, the heated liquid is dispensed from the reservoir with the motor-driven pump of the dispensing system. If the pump of the dispensing system is driven by an electric motor, the electric motor is energized via an operation of the on/off switch of the liquid control to receive electrical energy from the chosen power source of the cart, i.e. either the electrical generator or the electrical outlet. An operation of the variable frequency drive increases or decreases the motor's rotational rate to increase or decrease the flow rate of the pump. If the pump of the dispensing system is driven by a hydraulic motor, the hydraulic motor is energized via an operation of the hydraulic regulator to enable the motor to receive hydraulic energy from the hydraulic drive. An adjustment of the regulator increases or decreases the motor's rotational rate to increase or decrease the flow rate of the liquid pump of the dispensing system.

While this foregoing description and accompanying drawings are illustrative of the present invention, other variations in structure and method are possible without departing from the invention's spirit and scope.

We claim:

1. A portable cart for heating a liquid, maintaining the liquid in a heated state and dispensing the heated liquid comprising:
a frame;
an insulated housing carried by the frame and defining an interior space;
a reservoir and a dispensing system located within the interior space of the housing, the reservoir containing the liquid and the dispensing system in fluid communication with the reservoir;
a heat source located within the interior space of the housing and operably associated with the reservoir; and
a control operably associated with at least the heat source and the dispensing system.

2. The portable cart of claim 1 wherein the heat source comprises a plurality of resistive heating elements in contact with an outer surface of the reservoir.

3. The portable cart of claim 1 wherein the dispensing system comprises a pump in fluid communication with the reservoir and a dispensing hose in fluid communication with the pump, the pump driven by a motor operably associated with the control.

4. The portable cart of claim 3 wherein at least the heat source receives electrical energy from an electrical generator.

5. The portable cart of claim 4 wherein the pump motor receives electrical energy from the electrical generator.

6. The portable cart of claim 5 wherein the generator is located on the cart.

7. The portable cart of claim 4 wherein the pump motor receives hydraulic energy from a hydraulic drive.

8. The portable cart of claim 7 wherein the generator is driven by a hydraulic motor receiving hydraulic energy from the hydraulic drive.

9. The portable cart of claim 1 wherein the heat source maintains the liquid in the reservoir at a temperature of at least about 50 deg. F.

10. The portable cart of claim 1 wherein the heat source maintains the interior space of the housing at a temperature of at least about 35 deg.

11. The portable cart of claim 1 wherein the heat source maintains the liquid in the reservoir at a temperature of at least about 100 deg. F.

12. The portable cart of claim 1 wherein the liquid comprises a liquid adhesive.

13. The portable cart of claim 1 wherein the liquid comprises water.

14. The portable cart of claim 1 wherein the heat source comprises at least one indirect immersion heater located within the reservoir.

15. The portable cart of claim 1 wherein the insulated housing comprises a plurality of insulated sections defining a lower portion, at least one wall and an upper portion, the at least one wall portion defining at least one wall opening to enable access to at least the dispensing system, the upper portion defining at least one upper opening to enable access to at least the reservoir.

16. A method of heating a liquid, maintaining the liquid in a heated state with a portable cart and dispensing the liquid there-from comprising:
energizing a heat source operably associated with a reservoir located on the cart that holds the liquid;
heating the liquid and an interior space defined by a housing with the heat source, the housing located on the cart and enclosing both the reservoir and a dispensing system in fluid communication with the reservoir;
maintaining the liquid in the heated state; and
dispensing the heated liquid from the reservoir with a pump driven by a motor.

17. The method of claim 16 wherein the heat source receives electrical energy from an electrical generator.

18. The method of claim 17 wherein the pump motor receives electrical energy from the electrical generator.

19. The method of claim 18 wherein the generator is located on the cart.

20. The method of claim 17 wherein the pump motor receives hydraulic energy from a hydraulic drive.

21. The method of claim 20 wherein the generator is driven by a hydraulic motor receiving hydraulic energy from the hydraulic drive.

22. The method of claim 16 wherein the liquid is heated to a temperature of at least about 50 deg. F.

23. The method of claim 16 wherein the interior space of the housing is heated to a temperature of at least about 35 deg. F.

24. The method of claim 16 wherein the liquid is heated to a temperature of at least about 100 deg. F.

25. The method of claim 16 wherein the liquid comprises a liquid adhesive.

26. The method of claim 16 wherein the liquid comprises water.
